(19) United States
(12) Patent Application Publication
(10) Pub. No.: US 2017/0344334 A1
(43) Pub. Date: Nov. 30, 2017

(54) INFORMATION DISPLAY APPARATUS

(71) Applicant: MIMAKI ENGINEERING CO., LTD., Nagano (JP)

(72) Inventor: Masaru OHNISHI, Nagano (JP)

(73) Assignee: MIMAKI ENGINEERING CO., LTD., Nagano (JP)

(21) Appl. No.: 15/604,668

(22) Filed: May 25, 2017

(30) Foreign Application Priority Data
May 31, 2016 (JP) 2016-108183

(51) Int. Cl. G06F 3/14; H04L 29/06; G06Q 30/02; G09G 5/12

(52) U.S. Cl. CPC G06F 3/1454; G09G 5/12; H04L 63/083; G06Q 30/0241; G09G 2358/00; G09G 2354/00

(57) ABSTRACT

The present invention is to provide an information display apparatus capable of suppressing a possibility that relevant information may be visibly recognized to a person except for a user. An information display apparatus includes a signboard, which is an information display unit configured to display information, an IC chip, which is an information storage unit configured to store therein relevant information of the information displayed on the signboard, and a communication unit, which is an information transmission unit configured to transmit the relevant information stored in the signboard to an external electronic device, which is a display apparatus different from the signboard and is a relevant information display apparatus configured to display the relevant information, in correspondence to a user's operation.

### CROSS-REFERENCE TO RELATED APPLICATION

This application claims the priority benefit of Japanese Application Serial No. 2016-108183, filed on May 31, 2016. The entirety of each of the above-mentioned patent applications is hereby incorporated by reference herein and made apart of this specification.

### BACKGROUND OF THE INVENTION

### 1. Technical Field

The present invention relates to an information display apparatus configured to display information such as advertisement.

### 2. Related Art

In the related art, as an information display apparatus configured to display information such as advertisement, an information display apparatus that is to be equipped inside a station, a commercial facility and the like has been known (refer to Patent Document 1).

### Patent Document 1: JP-2011-150012A

However, the information display apparatus of the related art cannot display relevant information of the displayed information, in correspondence to a user's operation.

Also, even when it is possible to add a configuration capable of displaying the relevant information of the displayed information in correspondence to a user's operation to the information display apparatus of the related art, there is a possibility that the relevant information may be visibly recognized to a person except for the user.

### SUMMARY OF THE INVENTION

The present invention was made in view of the above described circumstances, and an object of the present invention is to provide an information display apparatus capable of suppressing a possibility that relevant information may be visibly recognized to a person except for a user.

In order to solve the above described problems and achieve the object, an information display apparatus according to the present invention includes an information display unit configured to display information, an information storage unit configured to store therein relevant information of the information to be displayed on the information display unit, and an information transmission unit configured to transmit the relevant information stored in the information storage unit to a relevant information display apparatus, which is a display apparatus different from the information display unit and is configured to display the relevant information, in correspondence to a user's operation.

By the above configuration, since the information display apparatus of the present invention can display the relevant information of the information to be displayed on the information display unit, on the display apparatus different from the information display unit, in correspondence to the user's operation, it is possible to suppress a possibility that the relevant information may be visibly recognized to a person except for the user.

Also, in the information display apparatus of the present invention, the relevant information may be information requiring a password for readout of at least a part thereof.

By the above configuration, the information display apparatus of the present invention enables only a specific user to acquire at least a part of the relevant information.

Also, in the information display apparatus of the present invention, the information storage unit may be a device capable of re-recording information.

By the above configuration, the information display apparatus of the present invention can change the relevant information, too, in correspondence to a change of the information to be displayed on the information display unit.

Also, in the information display apparatus of the present invention, the information storage unit may be configured to store therein information that is to be displayed by the information display unit, and the information display unit may be a display apparatus configured to display the information stored in the information storage unit.

By the above configuration, the information display apparatus of the present invention can easily change not only the relevant information but also the information that is to be displayed on the information display unit.

Also, in the information display apparatus of the present invention, the information storage unit may be an IC (Integrated Circuit) chip, and the information transmission unit may be a communication unit configured to transmit the relevant information to an external electronic device, which is the relevant information display apparatus, by at least one of contact communication and near field communication.

By the above configuration, since the information display apparatus of the present invention transmits the relevant information to the external electronic device by at least one of the contact communication and the near field communication, it is possible to enable a user of the electronic device to easily acquire the relevant information of the information to be displayed on the information display unit.

Also, the information display apparatus of the present invention may further include a power generation unit configured to generate power by electromagnetic waves to be generated from the external electronic device, and the power generation unit may be configured to feed power to the IC chip and the communication unit.

By the above configuration, since the information display apparatus of the present invention does not require a large-scale device for feeding power to the IC chip and the communication unit, it is possible to reduce a size of the information display apparatus.

The information display apparatus according to the present invention has an effect that it is possible to suppress the possibility that the relevant information may be visibly recognized to a person except for the user.

### BRIEF DESCRIPTION OF THE DRAWINGS

FIG. 1 is a configuration view of an information display apparatus according to an embodiment of the present invention.

FIG. 2 is a block diagram of an information storage device shown in FIG. 1.

FIG. 3 is a flowchart of the information storage device shown in FIG. 1 when a user is enabled to acquire a point of contact by which it is possible to further acquire information relating to a product displayed on a signboard.

FIG. 4 is a flowchart of the information storage device shown in FIG. 1 when the user is enabled to acquire a specification of the product displayed on the signboard.

FIG. 5 depicts an example of a password receiving screen that is to be displayed by an electronic device on the basis of password receiving screen information transmitted from the information storage device shown in FIG. 1.

### DETAILED DESCRIPTION OF PREFERRED EMBODIMENTS

Hereinafter, an embodiment according to the present invention will be described in detail with reference to the accompanying drawings.

First, a configuration of an information display apparatus according to the embodiment of the present invention is described.

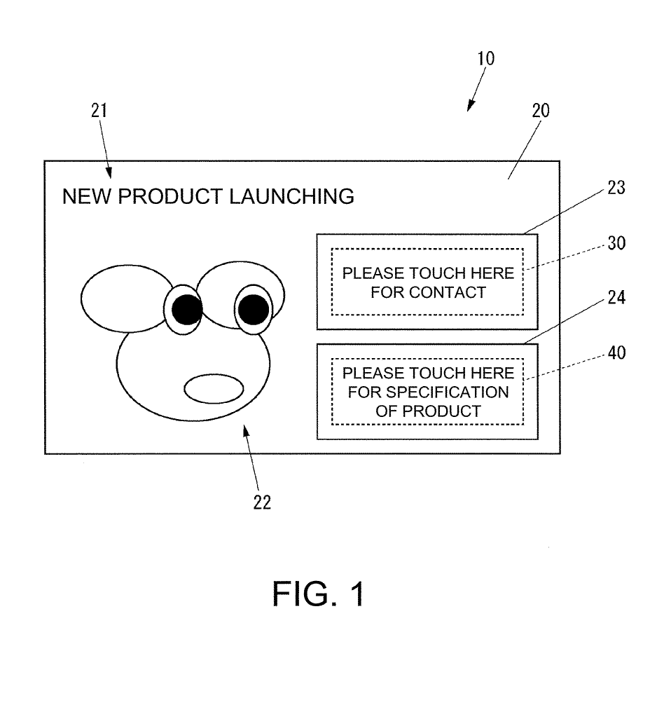

FIG. 1 is a configuration view of an information display apparatus 10 according to the embodiment.

As shown in FIG. 1, the information display apparatus 10 includes a signboard 20, which is an information display unit configured to display information such as advertisement, and an information storage device 30 and an information storage device 40 configured to store therein relevant information of the information to be displayed on the signboard 20.

The signboard 20 displays a message 21, which is information for notifying a new product launching, an image 22 of a target product of the message 21, an area 23 indicating a place with which a user is enabled to bring an electronic device into contact so as for the user to acquire, as relevant information of the message 21 and the image 22, a point of contact by which it is possible to further acquire information about the target product of the message 21 and the image 22, and an area 24 indicating a place with which the user is enabled to bring the electronic device into contact so as for the user to acquire, as the relevant information of the message 21 and the image 22, a specification of the target product of the message 21 and the image 22.

In the meantime, the electronic device configured to acquire the relevant information is an electronic device having an IC (Integrated Circuit) card reader, for example a portable terminal such as a smart phone, and a PC (Personal Computer). The electronic device configures a display apparatus configured to display the relevant information, i.e., a relevant information display apparatus.

The information storage device 30 and the information storage device 40 are embedded in the signboard 20.

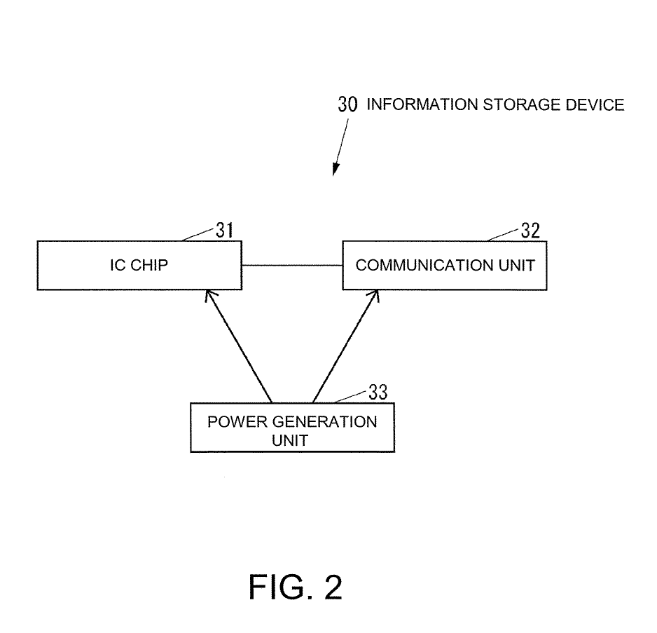

FIG. 2 is a block diagram of the information storage device 30.

As shown in FIG. 2, the information storage device 30 includes an IC chip 31, which is an information storage unit configured to store therein a point of contact, a communication unit 32, which is an information transmission unit configured to transmit the point of contact to an external electronic device by near field communication, and a power generation unit 33 configured to generate power by electromagnetic waves to be generated from the external electronic device.

The IC chip 31 is a device capable of re-recording information.

The power generation unit 33 is a wiring wound in a spiral shape so as to generate power by electromagnetic induction resulting from a change in electromagnetic waves passing therethrough. The power generation unit 33 is configured to feed power to the IC chip 31 and the communication unit 32. In the meantime, the power generation unit 33 may be configured to also function as an antenna of the communication unit 32.

The information storage device 40 shown in FIG. 1 has the same configuration as the information storage device 30, except that a specification of the product displayed on the signboard 20 is stored therein.

Subsequently, operations of the information display apparatus 10, which are performed when the relevant information is acquired by the user of the electronic device, are described.

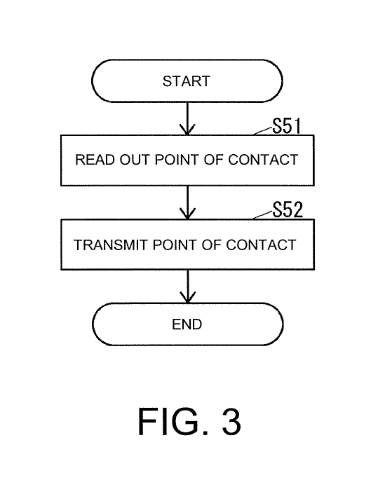

FIG. 3 is a flowchart of the information storage device 30 when a user is enabled to acquire a point of contact by which it is possible to further acquire information relating to the product displayed on the signboard 20.

When the user of the electronic device brings the electronic device into contact with the area 23, the power generation unit 33 generates power by the electromagnetic waves generated from the electronic device and the power generated by the power generation unit 33 is fed to the IC chip 31 and the communication unit 32, so that the information storage device 30 starts operations shown in FIG. 3.

As shown in FIG. 3, the IC chip 31 reads out a point of contact from a storage area of the IC chip 31 (S51).

Then, the IC chip 31 transmits the point of contact read out in S51 to the external electronic device via the communication unit 32 by the near field communication (S52), and ends the operations of FIG. 3.

Therefore, the electronic device can receive the point of contact transmitted from the information storage device 30 by the near field communication and display the received point of contact on a display unit (not shown).

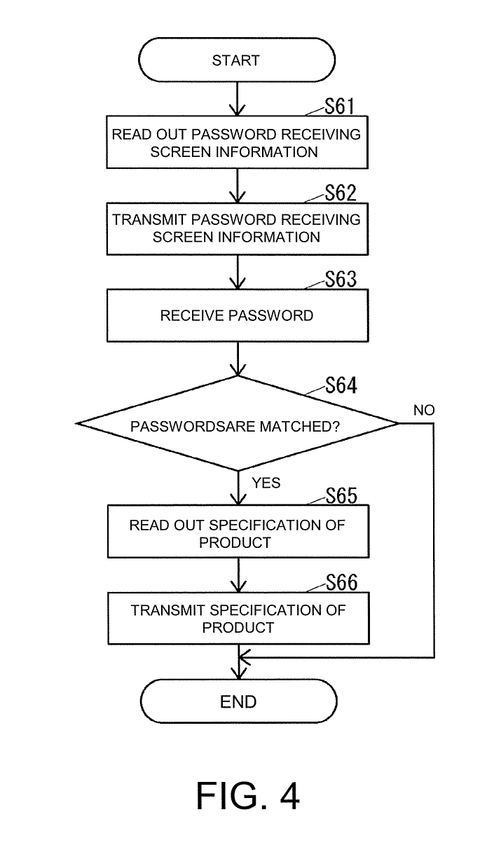

FIG. 4 is a flowchart of the information storage device 40 when the user is enabled to acquire a specification of the product displayed on the signboard 20.

When the user of the electronic device brings the electronic device into contact with the area 24, the information storage device 40 generates power in the same manner as the information storage device 30 and starts operations of FIG. 4.

As shown in FIG. 4, the IC chip of the information storage device 40 reads out information (hereinafter, referred to as “password receiving screen information”) of a screen (hereinafter, referred to as “password receiving screen”) for receiving a password from a storage area of the IC chip (S61).

Then, the IC chip of the information storage device 40 transmits the password receiving screen information read out in S61 to the external electronic device via the communication unit of the information storage device 40 by the near field communication (S62).

Therefore, the electronic device can receive the password receiving screen information transmitted from the information storage device 40 by the near field communication and display the password receiving screen on a display unit (not shown), based on the received password receiving screen information.

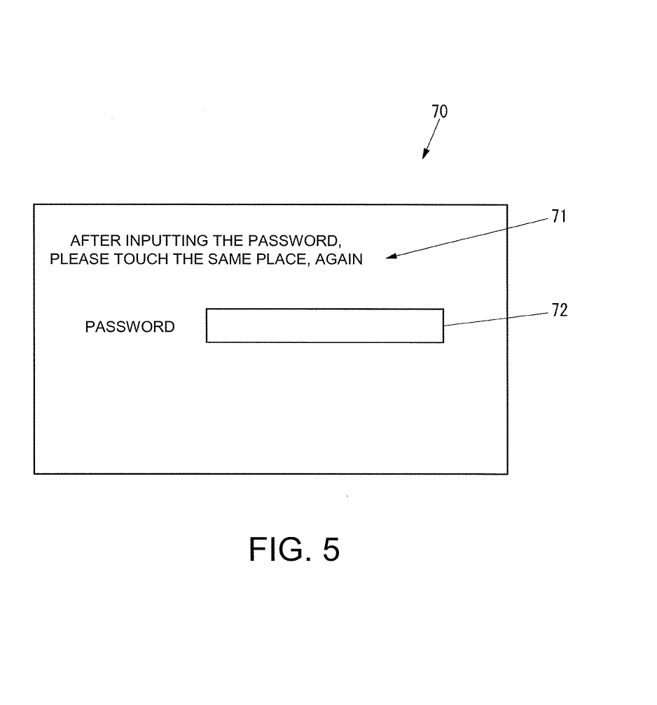

FIG. 5 depicts an example of a password receiving screen 70 that is to be displayed by the electronic device on the basis of the password receiving screen information transmitted from the information storage device 40.

As shown in FIG. 5, the password receiving screen 70 includes a message 71 and a text box 72, where the message 71 for urging the user to again bring the electronic device into contact with the area 24 (refer to FIG. 1) after inputting a password, and the text box 72 is for inputting a password.

When the user again brings the electronic device into contact with the area 24 after inputting a password to the text box 72 via an operation unit (not shown) of the electronic device, the IC chip of the information storage device 40 receives the password input to the text box 72 from the electronic device via the communication unit of the information storage device 40 by the near field communication (S63), as shown in FIG. 4.

Then, the IC chip of the information storage device 40 determines whether the password received in S63 and a password stored in the storage area of the IC chip are matched each other (S64).

When it is determined in S64 that the passwords are not matched each other, the IC chip of the information storage device 40 ends the operations of FIG. 4.

On the other hand, when it is determined in S64 that the passwords are matched each other, the IC chip of the information storage device 40 reads out the specification of the product displayed on the signboard 20 from the storage area of the IC chip (S65).

Then, the IC chip 31 transmits the specification read out in S65 to the external electronic device via the communication unit of the information storage device 40 by the near field communication (S66) and ends the operations of FIG. 4.

Therefore, the electronic device can receive the specification transmitted from the information storage device 40 by the near field communication and display the received specification on the display unit (not shown).

As described above, the information display apparatus 10 can display the relevant information of the information displayed on the signboard 20, on the electronic device, which is a display apparatus different form the signboard 20, in correspondence to the user's operation. Therefore, it is possible to suppress a possibility that the relevant information may be visibly recognized to a person except for the user.

The information display apparatus 10 requires the password for readout of the specification of the product. Therefore, it is possible to enable only a specific user, i.e., a user who knows the password to acquire the specification of the product.

In the embodiment, the information display apparatus 10 requires the password for readout of only the specification of the product, i.e., only a part of the relevant information. However, the information display apparatus 10 may require the password for readout of all the relevant information. Also, the information display apparatus 10 may not require the password for readout of all the relevant information.

The information display apparatus 10 includes the IC chip capable of re-recording the information in the information storage device. Therefore, the relevant information in the IC chip can also be changed in correspondence to a change of the information that is to be displayed on the signboard 20.

The signboard 20 may be a display apparatus such as an LCD (Liquid Crystal Display) configured to display the information stored in the IC chip. By this configuration, the information display apparatus 10 can easily change not only the relevant information but also the information that is to be displayed on the signboard 20.

The information display apparatus 10 is configured so that the information storage device 30 and the information storage device 40 are to transmit the relevant information to the external electronic device by the near field communication. Therefore, it is possible to enable the user of the electronic device to easily acquire the relevant information of the information displayed on the signboard 20.

Since the information display apparatus 10 includes the power generation unit configured to generate power by the electromagnetic waves generated from the external electronic device, it is not necessary to provide the information storage device with a large-scale device for feeding power to the IC chip and the communication unit. Therefore, the information display apparatus 10 can be made small and a degree of arrangement freedom of the information storage devices can be improved.

In the meantime, the information storage device may include a power generation unit configured to generate power by a method except for the method described in the embodiment, such as photovoltaic generation. Also, the information storage device may not have the power generation unit and may be configured so that power is to be fed thereto from a battery or a commercial power supply.

In the embodiment, the information display apparatus 10 has the information storage device embedded in the signboard 20. However, the information storage device may be arranged at a place spaced from the signboard 20. For example, the information storage device may be arranged within a range in which the user who receives the relevant information from the communication unit by the external electronic device can visibly recognize the information displayed on the signboard 20.

In the embodiment, the information storage device of the information display apparatus 10 is configured to perform near field communication with the external electronic device by radio waves. However, the information storage device may also be configured to perform near field communication with the external electronic device by a method except for the radio waves, such as infrared communication. Also, the information storage device may be configured to perform communication by a physical contact between the external electronic device and a terminal, not by the near field communication.

In the embodiment of the information display apparatus 10, the external electronic device is configured as the relevant information display apparatus. However, the information display apparatus 10 may have the relevant information display apparatus. For example, the information display apparatus 10 may have a small display apparatus separate from the signboard 20, as the relevant information display apparatus. Also, when the signboard 20 is a display apparatus, a part of the signboard 20 may be configured as the information display unit and the remaining of the signboard 20 may be configured as the relevant information display apparatus. When the information display apparatus 10 has the relevant information display apparatus, the communication method of the information transmission unit may be a wired method.

In the embodiment, the information display apparatus 10 has the IC chip, as the information storage unit. However, the information display apparatus 10 may have a storage device except for the IC chip, such as an HDD (Hard Disk Drive), as the information storage unit.

In the embodiment of the information display apparatus 10, character information has been exemplified as the relevant information. However, the information display apparatus 10 may adopt, as the relevant information, a variety of information such as an image, a video picture and, voice in addition to the character information.

What is claimed is:

1. An information display apparatus, comprising:
an information display unit configured to display information;
an information storage unit configured to store therein relevant information of the information to be displayed on the information display unit; and
an information transmission unit configured to transmit the relevant information stored in the information storage unit to a relevant information display apparatus, which is a display apparatus different from the information display unit and is configured to display the relevant information, in correspondence to a user's operation.

2. The information display apparatus according to claim 1, wherein the relevant information is information requiring a password for readout of at least a part thereof.

3. The information display apparatus according to claim 2, wherein the information storage unit is a device capable of re-recording information.

4. The information display apparatus according to claim 3, wherein the information storage unit is configured to store therein the information that is to be displayed by the information display unit, and
wherein the information display unit is a display apparatus configured to display the information stored in the information storage unit.

5. The information display apparatus according to claim 4, wherein the information storage unit is an IC (Integrated Circuit) chip, and
wherein the information transmission unit is a communication unit configured to transmit the relevant information to an external electronic device, which is the relevant information display apparatus, by at least one of contact communication and near field communication.

6. The information display apparatus according to claim 5, further comprising a power generation unit configured to generate power by electromagnetic waves to be generated from the external electronic device, and
wherein the power generation unit is configured to feed power to the IC chip and the communication unit.
